(19) United States
(12) Patent Application Publication
(10) Pub. No.: US 2009/0287599 A1
(43) Pub. Date: Nov. 19, 2009

(54) Monetary Transfer Approval Via Mobile Device

(75) Inventors: Joe N. Lamar, III, Lithia Springs, GA (US); Sean Datcher, Keller, TX (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 12/121,164

(22) Filed: May 15, 2008

(51) Int. Cl. G06Q 40/00

(52) U.S. Cl. 705/39

(57) ABSTRACT

A mobile monetary transfer approval process is provided that allows clients to approve or reject monetary transfer requests by utilizing the client's mobile device, such as a cellular telephone and/or personal digital assistant (PDA). From such a client mobile device, user may view pending outgoing and incoming payments and approve or reject them in real time. In addition, an alert may be sent to the client mobile device responsive to the monetary transfer request being initiated. This may allow the client using the client mobile device to know when it is appropriate to go through the approval process, rather than having to periodically check for new monetary transfer requests.

### BACKGROUND

Many bank clients such as corporate clients have monetary transfer review and approval processes. These clients may, for instance, receive requests to approve a wire, to make a decision on a return/positive pay item, or to approve some other monetary transfer. When such a client initiates a payment, usually the initiator of the transfer is a subordinate of the approver, or else the process is set up such that the same person cannot both initiate and approve a payment. The transfer initiator starts the transfer process from their computer, and the approver must be at another computer to view, approve, and release the transfer.

However, this method of review and approving monetary transfers ties the customer to their computing infrastructure and limits their mobility and flexibility in completing the review and approval tasks. Clients today are always on the go. Many times they are not physically at the client's computer system when the need for a monetary transfer review comes up. Moreover, to become aware of the existence of monetary transfers needing review, clients will periodically or continuously poll a bank website or a desktop application to review these monetary transfers. This can become burdensome, inconvenient, and impose an increased load on the client's and the bank's computing network.

### SUMMARY

It would be desirable to provide a way for clients to review and approve/reject monetary transfer requests without being tied to a fixed location computer system. It would further be desirable to provide a way to notify clients of pending monetary transfer requests without needing the client to continuously or periodically check for the existence of such monetary transfer requests.

According to some aspects as described herein, a mobile monetary transfer approval process may be provided that allows clients to view and approve or reject monetary transfer requests by utilizing the client's mobile device, such as a cellular telephone and/or personal digital assistant (PDA).

The clients may thereby have unencumbered access to mobile banking functions from their client mobile devices. From such a client mobile device, they can view pending outgoing and incoming payments and approve or reject them in real time. This may save clients the time of having to locate, boot up, and log into a computer. It may provide clients the flexibility to approve and release or reject a pending payment or other transfer from anywhere in the world that receives a cell phone, Wi-Fi, or other wireless signal. This added flexibility may speed up the payment process, thereby potentially providing additional liquidity to the market.

According to further aspects, an alert may be sent to the client mobile device responsive to a monetary transfer request being initiated. This may allow the client using the client mobile device to know when it is appropriate to go through the approval process, rather than having to periodically check for new monetary transfer requests.

These and other aspects of the disclosure will be apparent upon consideration of the following detailed description.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a functional block diagram of an illustrative system for implementing mobile device monetary transfer approvals.

FIGS. 2-4 together show a flowchart of illustrative steps that may be performed by the system of FIG. 1.

FIG. 5 is an illustrative screenshot of information that may be displayed by the client mobile device in connection with the system of FIG. 1.

### DETAILED DESCRIPTION

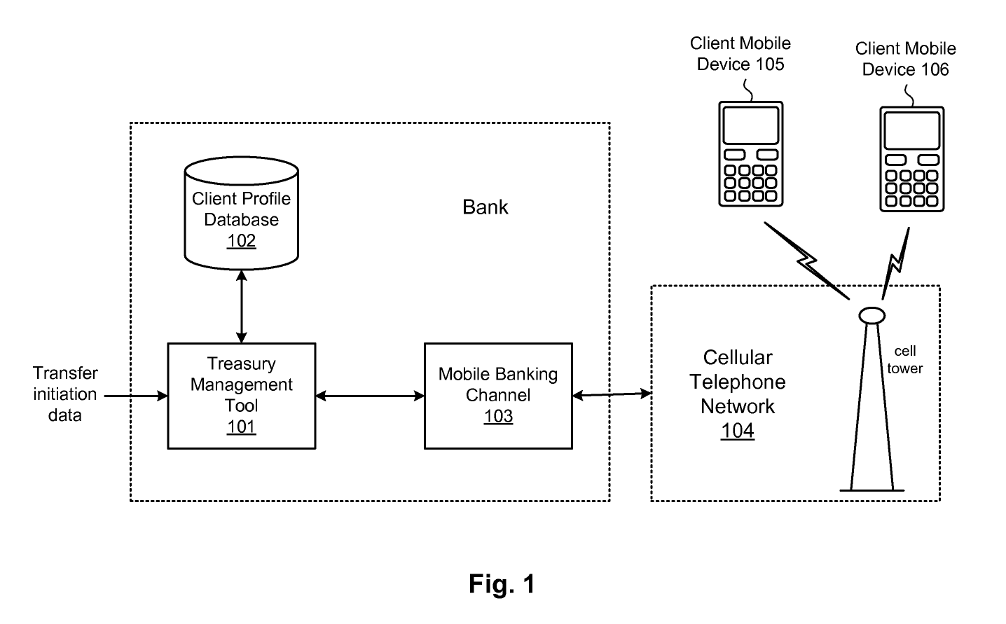

FIG. 1 is a functional block diagram of an illustrative system for implementing mobile device monetary transfer approvals. In this example, the system includes a treasury management tool 101, a client profile database 102, a mobile banking channel 103, a cellular network 104, and one or more client mobile devices 105, 106. In the present example, treasury management tool 101, client profile database 102, and mobile banking channel 103 may be part of a bank or other financial institution. Within the broken line indicating the bank, the various blocks 101-103 are merely divided by function. These blocks 101-103 may be physically combined and/or further subdivided in any manner desired that is the same as or different from the divisions shown.

Each of blocks 101-103 may be implemented as or otherwise include a computing device, which as referred to herein includes any electronic, electro-optical, and/or mechanical device or system of devices that is able to process and manipulate information, such as in the form of data. Non-limiting examples of a computing devices includes a personal computer, a server, and/or a system of these in any combination. In addition, a computing device may be physically all in one location or may be distributed amongst a plurality of locations (i.e., may implement distributive computing).

In addition, client profile database 102 may include or otherwise have read/write access to any one or more data storage media, such as but not limited to one or more memory chips, one or more magnetic storage disks (e.g., hard drives), one or more optical storage disks (e.g., compact disks, or CDs, along with their respective drives), and/or one or more magnetic tape drives. These data storage media are also referred to as computer-readable media. The term “computer-readable medium” as used herein includes not only a single medium or type of medium, but also to a combination of one or more media and/or types of media. Such a computer-readable medium may store computer-readable instructions (e.g., software) and/or computer-readable data.

Treasury management tool 101 and mobile banking channel 103 may further each include a computer-readable medium for storing data and/or software that may be used by these respective functions 101 and 103 to perform any of the functions attributed to those blocks.

Cellular telephone network 104 may be any conventional or modified cellular telephone network, such as those cellular telephone networks presently operated by Verizon, AT&T, and Sprint. Client mobile device 105 and 106 may also communicate via a Wi-Fi (wireless network connectivity) Internet connection with mobile banking channel 103, with or without cellular network 104, such as via those Wi-Fi Internet connections provided by local municipalities, home networks, or for profit businesses with Wi-Fi Hotspots such as those offered at Starbuck's Coffee and T-Mobile storefront locations. As shown, the bank (and in this particular example, mobile banking channel 103) may have a bidirectional communication path with cellular telephone network 104 and/or with such a Wi-Fi network. This communication path may allow the bank to send and receive data to and from other locations accessible through the cellular telephone network 103. For instance, this communication path may allow mobile banking channel 103 to send data to, and receive data from, client mobile device 105.

Client mobile devices 105 and 106 may each be any type of computing device capable of communicating bi-directionally and wirelessly with cellular telephone network 104 and/or via a Wi-Fi network connection. For example, client mobile devices 105 and 106 may each be or include a cellular telephone or other type of wireless telephone. Client mobile devices 105 and 106 may further include additional computing functionality such as by operating as a personal digital assistant (PDA) or a smart phone. As is well-known, such client mobile devices 105 and 106 also contain a computer-readable medium for storing data and/or software that controls the operations of client mobile devices 105 and 106. Client mobile devices 105 and 106 may therefore run one or more software applications, such as an Internet web browser and an email application, and one or more operating systems, such as the Microsoft WINDOWS MOBILE operating system, RIM (Research In Motion found in BlackBerry devices), Google Android, Symbian, or the PALM operating system.

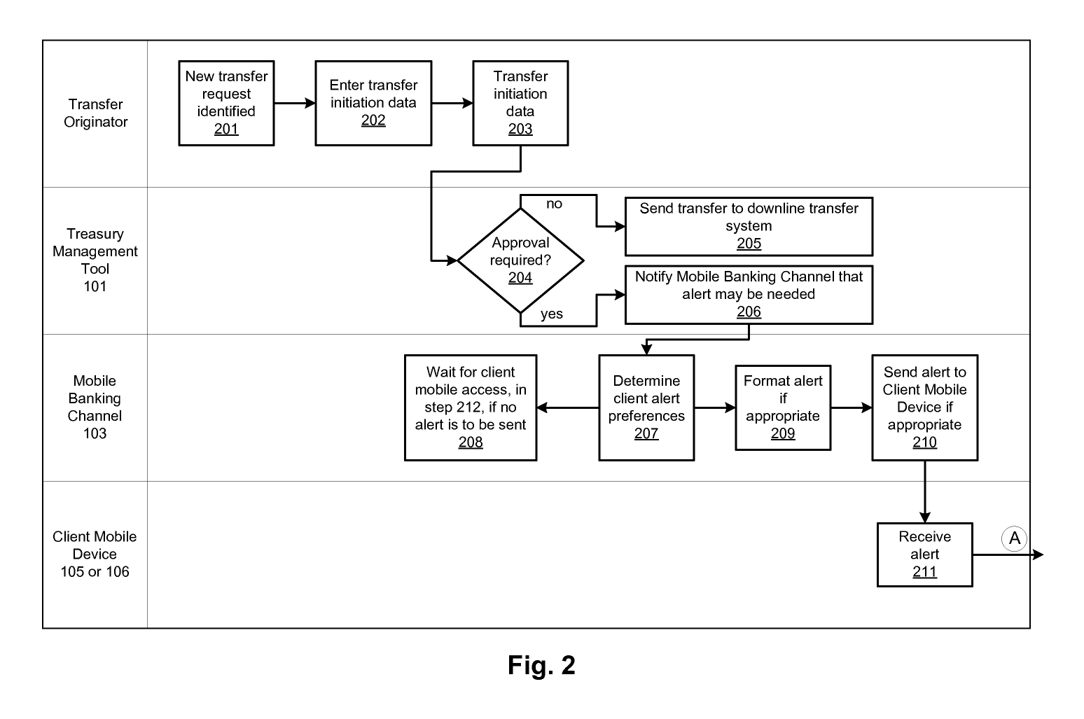

The system of FIG. 1 may operate in the manner shown in FIGS. 2-4. Beginning with FIG. 2, in step 201 a new transfer request is identified by a transfer originator. The transfer originator may be, for example a person authorized by the client to initiate a monetary transfer request. For example, where the client is a corporate client, the transfer originator may be an authorized person in the accounting department of the corporate client. Next, in step 202, the transfer originator enters transfer initiation data into a computer system that is under the control of the transfer originator (e.g., a computer terminal on the client premises). The transfer initiation data may include information about the requested monetary transfer. This information may include an identification of the type of the monetary transfer, such as a payment, an account transfer, a positive payment, an electronic funds transfer (ACH), a wire payment, or a fee payable. This information may further include an indication of the amount of money to be transferred, and the transferor (e.g., payor) and/or transferee (e.g., payee) account. In step 203, this transfer initiation data is transferred to the bank, such as by a network (e.g., the Internet). In particular, the transfer initiation data may be received by treasury management tool 101.

In step 204, treasury management tool determines, based at least on the transfer initiation data, whether approval of the associated monetary transfer request is required. Factors that may be used to determine whether approval is required may include, for example, the amount of money requested to be transferred (e.g., if the amount of the present transfer or a cumulative amount of several transfers are over a predetermined threshold amount, then approval is required, otherwise approval may not be required); the identity of the transferor and/or transferee; the time of day; the day of week; the date; the identity of the client-transfer originator; and/or the type of transfer requested. If not, then in step 205 the monetary transfer request is transferred to a downline transfer handling system, as in a conventional banking system. However, if approval is required, then in step 206 treasury management tool 101 notifies mobile banking channel 103 that an alert may be needed to be sent. As will be described further, the alert may be sent to one of the client mobile devices 105 or 106, so that the client using that device may be aware of the pending monetary transfer request. As will also be described further, an alert may or may not be sent, depending upon one or more factors.

Responsive to being notified in step 206, mobile banking channel 103 determines client alert preferences in step 207. For example, step 207 may include determining both (a) whether the alert should be sent or withheld, and (b) if the alert should be sent, how it should be sent. Both (a) and (b) may be determined by referring to client profile database 102.

Client profile database 102 may include data representing client alert preferences associated with each client. The data may be organized in any manner desired, such as in a relational database that responds to structured query language (SQL) queries and commands or Rules Engine structures that store business logic that can be evaluated during runtime. The client alert preferences may include, for example, an indication of time limitations that affect when an alert should be sent. For instance, the client preferences may indicate that an alert should be sent only at certain times of day, on certain days of the week, on certain dates, and the like. As an example, it may be desired for a given client that an alert be sent only on weekdays. As another example, it may be desired for a given client that an alert be sent only on weekdays to a first client mobile device, and only on weekends to a second client mobile device. Yet another example of a time limitation is an indication of how long to wait after a previously sent alert before a new alert may be sent. The client alert preferences may also include, for example, an indication of a threshold number of monetary transfer requests that should accumulate before an alert is sent, thereby allowing for batching of monetary transfer requests into a combined alert.

The client alert preferences may further include an indication of how the alert should be sent for a given client. For instance, it may be indicated whether the alert should be sent by email, by a telephone call (e.g., with a recording or automated speech generator), or by a text message, such as a Short Message Service (SMS) text message, and also what type of format the alert should be in. The format may include an indication of the email type (e.g., HTML email versus plain text email), the amount of detail to be provided in the alert (e.g., whether to include an indication of the monetary value of the requested transfer and/or the parties involved, or in the extreme alternative merely an indication that a monetary transfer request exists). The client alert preferences may further include an indication of where the alert should be sent. For instance, it may be indicated that a given alert should be sent to client mobile device 105 or to client mobile device 106, such as by indicating the particular phone number and/or email address of that client mobile device. The various client alert preferences may be implemented in any combination by a rules engine that is part of mobile banking channel 103.

Thus, returning to FIG. 2, the outcome of step 207 may be an indication of whether the alert should be sent, and if so how the alert should be sent. If it is determined that the alert should not be sent, then the process moves to step 208 and waits for further action, such as client mobile device 105 or 106 accessing the system to review one or more monetary transfer requests (as will be described further below).

If it is determined that the alert should be sent, then in step 209 the alert is generated and formatted in accordance with the previously determined client alert preferences. Then, in step 210, the alert is sent by the appropriate communication method and in the appropriate format to the appropriate client mobile device, in accordance with the previously determined client alert preferences. For example, mobile banking channel 103 may send an alert to cellular telephone network 104, requesting that a text message be wirelessly sent to client mobile device 105. To do so, mobile banking channel 103 may send data to cellular telephone network 104 that includes both the alert content and an indication of the destination of the alert, such as the phone number of client mobile device 105 and/or an email address associated with client mobile device 105. The alert is then received by client mobile device 105 in step 211.

As previously mentioned, the alert may include any desired amount of information about the monetary transfer request, as defined in the client alert preferences stored in client profile database 102. Examples of information that may be included in the alert are an identification of the transferor and/or the transferee, an identification of the account of the transferor and/or the transferee, an identification of the amount of money to be transferred, an identification of the transfer originator, an identification of the date and time that the monetary transfer request was originated. Alternatively, the alert may be a simple indication that the monetary transfer request exists, without further details. The alert may further include an indication of how the client should go about reviewing the monetary transfer request. For instance, the alert may include a user-selectable hyperlink to an Internet web page from which the client may log into mobile banking channel 103 (measures such as the implementation of Bank of America Site-key may be included to prevent e-mail phishing scams). Also, where multiple monetary transfer requests have occurred prior to sending the alert (and have not already been included in another alert), the alert may include the desired information about all of those pending monetary transfer requests in a single alert.

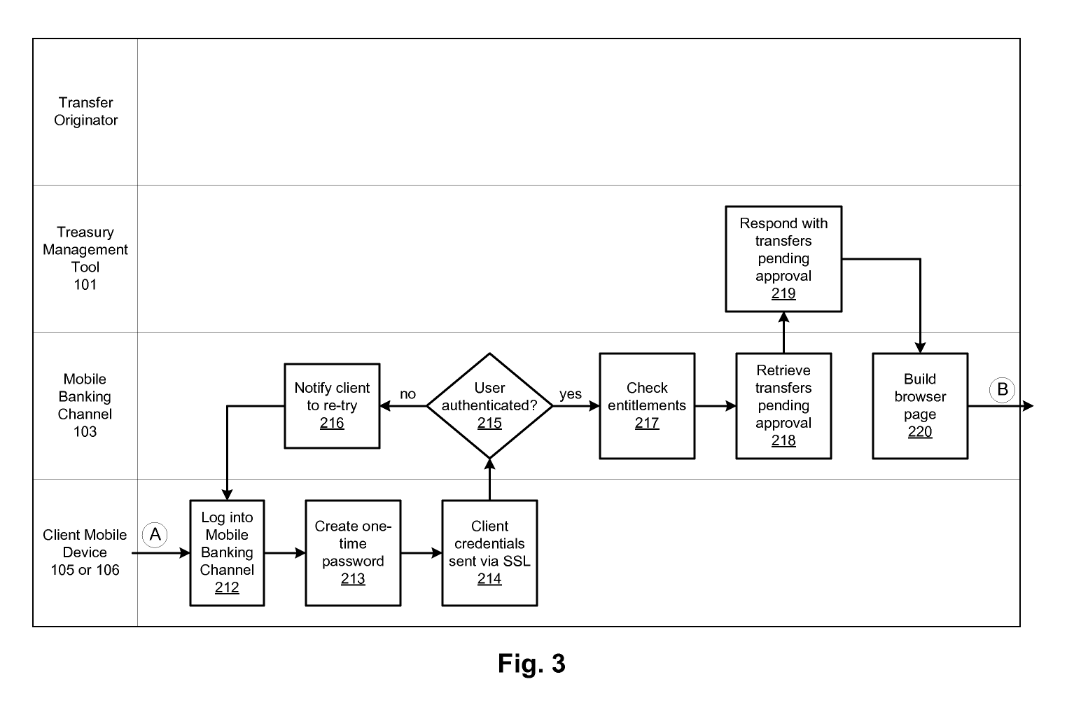

Referring to FIG. 3, client mobile device 105 may indicate to the user of that device 105 that the alert has been received. This may occur, for example, by an indication of the alert being displayed on a display of client mobile device 105, and/or by an audible sound and/or tactile output generated by a speaker and/or vibrator of client mobile device 105. Alternatively, the user may periodically check his or her email or other messaging mechanism to determine whether a notification indicating a pending payment requiring the users attention has been received.

In response to receiving the alert, in step 212 the user of client mobile device 105 may decide to log into mobile banking channel 103 (such as by selecting the hyperlink included in the alert). Of course, the user may decide to log into mobile banking channel 103 at any time, regardless of whether an alert has been received. The user may then be subjected to one or more security requirements before being allowed to pass through. For example, in steps 213-215, a one-time password may be created, and compared with a password entered by the user of client mobile device 105. The one-time password may be determined by the user such as through a hardware or software token in the possession of the user. Alternatively, the password may be a standard multi-use password.

If in step 215 mobile banking channel determines that the password is incorrect or if the user is not authenticated for some other reason, then the user is notified in step 216 to re-try the log-in process. But if the user is properly authenticated in step 215, then in step 217 mobile banking channel 103 checks the entitlements of the authenticated user. The entitlements of the user may include, for instance, whether the user is able to simply review the monetary transfer request, or whether the user is able to additionally approve or reject the monetary transfer request.

Next, in step 218, mobile banking channel 103 queries treasury management tool 101 for any pending monetary transfer requests. Treasury management tool 101 responds in step 219 with the pending requests. In step 220, mobile banking channel 103 builds an Internet browser-compatible web page in accordance with client preferences (that may also be stored in client profile database 102). The web page is rendered in step 221, and in step 222 the web page is wirelessly sent via cellular telephone network 104 and/or via a Wi-Fi connection to client mobile device 105.

Client mobile device 105 then displays the rendered web page, and in step 223 the user of client mobile device 105 may interact with the web page to take approval or rejection action on each monetary transfer request, as desired.

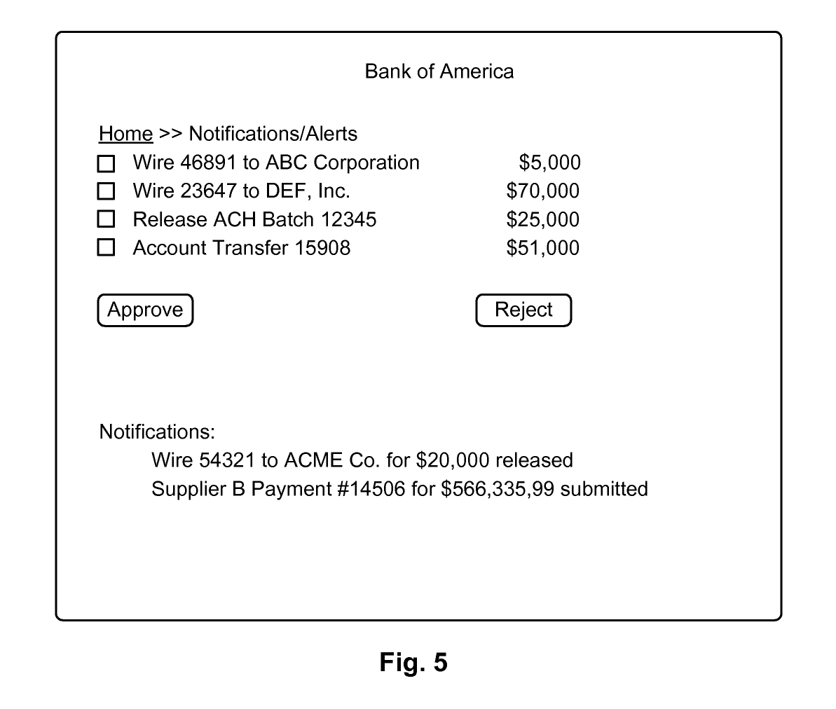

An example of such a displayed web page is shown in FIG. 5. In this example, four different monetary transfer requests are indicated: a wire number 46891 to ABC Corporation in the amount of $5,000; a wire number 23647 to DEF, Inc., in the amount of $70,000; a release of ACH batch number 12345 in the amount of $25,0000; and an account transfer number 15908 in the amount of $51,000. Next to each indicated monetary transfer request is a user-selectable checkbox. The user may check or uncheck any of the listed monetary transfer requests and then select the appropriate Approve or Reject button to act on those requests having a check in the respective checkbox. Of course, this user interface is merely illustrative, and other user interfaces are possible. The web page as shown further includes an indication of the status of previously managed monetary transfer requests. In this example, it is indicated that a wire number 54321 was released and that a payment number 14506 to Supplier B was submitted. This may be useful information in the event that more than one client mobile device (and user thereof) is authorized to approve/reject pending monetary transfer requests for a given client.

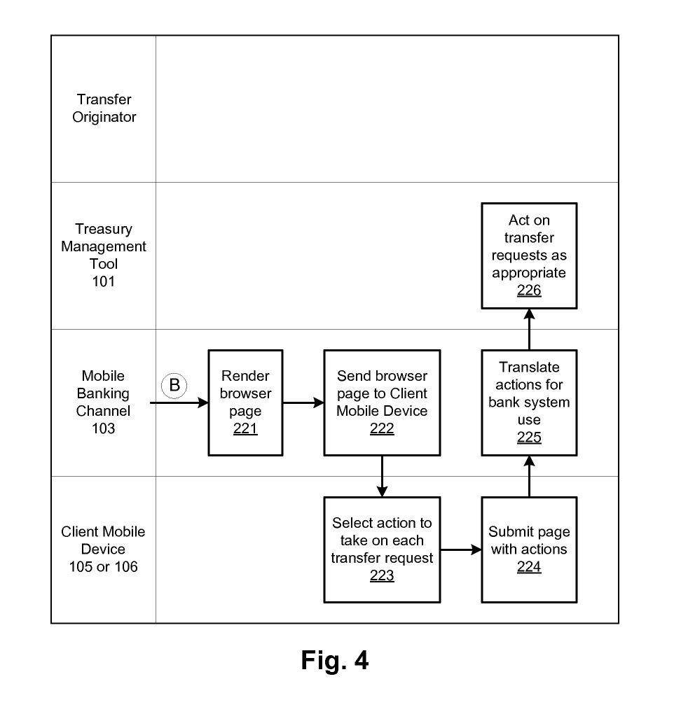

Returning to FIG. 4, in step 224 data representing an indication of an approval or rejection action, based on the user input described previously, is wirelessly sent to mobile banking channel 103 via cellular telephone network 104. In step 225, mobile banking channel 103 translates these actions, if necessary, into a format that is compatible with the remainder of the banking system. In step 226, these translated actions are acted on by treasury management tool 101 as appropriate. For instance, treasury management tool 101 may cause the relevant monetary transfer requests to be approved or rejected in a conventional manner, based on the translated actions received from mobile banking channel 103.

Thus, illustrative embodiments of a mobile monetary transfer approval process have been described that allow clients to approve or reject monetary transfer requests by utilizing the client's mobile device. This may allow clients to go about their business without being tied to a fixed location computer system and without needing the client to continuously or periodically check for the existence of such monetary transfer requests.

What is claimed is:

1. A computer-implemented method, comprising:
receiving a monetary transfer request; and
in response to receiving the monetary transfer request, sending alert data to a cellular telephone network.

2. The computer-implemented method of claim 1, wherein the monetary transfer request is a request for a payment.

3. The computer-implemented method of claim 1, further comprising:
receiving from the cellular telephone network an indication of whether the monetary transfer request is approved; and
either approving or rejecting the monetary transfer request depending upon the indication.

4. The computer-implemented method of claim 1, wherein the alert data includes data representing an amount of money to be transferred by the monetary transfer request.

5. The computer-implemented method of claim 1, wherein sending comprises sending both the alert data and a phone number to the cellular telephone network.

6. The computer-implemented method of claim 5, further comprising determining the phone number based on the monetary transfer request.

7. The computer-implemented method of claim 1, further comprising transferring monetary value in accordance with the monetary transfer request.

8. A computer-implemented method, comprising:
sending to a cellular telephone network first data identifying a monetary transfer request;
receiving from the cellular telephone network second data indicating whether the monetary transfer request is approved; and
either approving or rejecting the monetary transfer request depending upon the second data.

9. The computer-implemented method of claim 8, further comprising determining a phone number based on the monetary transfer request, wherein the first data further identifies the phone number.

10. The computer-implemented method of claim 8, further comprising determining an email address based on the monetary transfer request, wherein the first data further identifies the email address.

11. The computer-implemented method of claim 8, further comprising transferring monetary value in accordance with the monetary transfer request.

12. The computer-implemented method of claim 8, wherein the first data includes an indication of an amount of money requested to be transferred by the monetary transfer request.

13. The computer-implemented method of claim 8, wherein the monetary transfer request is a request for a payment.

14. A computer-implemented method, comprising:
receiving a monetary transfer request;
selecting, based on the monetary transfer request, a method of communication with a client mobile device; and
sending to the client mobile device, using the selected method of communication, first data identifying the monetary transfer request.

15. The computer-implemented method of claim 14, further comprising:
receiving from the client mobile device second data indicating whether the monetary transfer request is approved; and
either approving or rejecting the monetary transfer request depending upon the second data.

16. The computer-implemented method of claim 14, further comprising transferring, responsive to the monetary transfer request being approved, monetary value.

17. The computer-implemented method of claim 14, wherein sending comprises sending the first data to the client mobile device via a cellular telephone network.

18. A computer-implemented method implemented by a client mobile device, the method comprising:
wirelessly receiving at a wireless telephone an alert identifying a monetary transfer request;
displaying the alert;
receiving user input after displaying the alert; and
depending upon the user input, wirelessly sending data indicating either an approval or a disapproval of the monetary transfer request.

19. The computer-implemented method of claim 18, wherein displaying comprises launching a web browser on the client mobile device and displaying the alert in the web browser.

20. The computer-implemented method of claim 18, wherein receiving comprises receiving the alert as either an email or a Short Messaging Service (SMS) text message.

21. A computer-implemented method, comprising:
receiving a monetary transfer request; and
in response to receiving the monetary transfer request, sending an alert to a client mobile device via either a Short Message Service (SMS) text message or an email.

22. The computer-implemented method of claim 21, wherein the alert includes an indication of an amount of money proposed to be transferred by the monetary transfer request.

23. A computer-implemented method, comprising:
receiving a monetary transfer request; and
in response to receiving the monetary transfer request, sending an alert to a telephone number of a client mobile device.

24. The computer-implemented method of claim 23, wherein the alert includes an indication of an amount of money proposed to be transferred by the monetary transfer request.
